(19) United States
(12) Patent Application Publication
(10) Pub. No.: US 2014/0291166 A1
(43) Pub. Date: Oct. 2, 2014

(54) METHOD AND KIT FOR ELECTROCHEMICALLY DETECTING ANALYTE

(71) Applicant: SYSMEX CORPORATION, Kobe-shi (JP)

(72) Inventors: Fumiya FUTAMATSU, Kobe-shi (JP); Hiroya KIRIMURA, Ashiya-shi (JP); Shigeki IWANAGA, Kobe (JP); Seigo SUZUKI, Ashiya-shi (JP); Nobuyasu HORI, Kobe (JP); Yuichi YASUDA, Kobe-shi (JP)

(73) Assignee: SYSMEX CORPORATION, Kobe-shi (JP)

(21) Appl. No.: 14/227,758

(22) Filed: Mar. 27, 2014

(30) Foreign Application Priority Data
Mar. 28, 2013 (JP) 2013-070074

(51) Int. Cl. G01N 27/26

(52) U.S. Cl. CPC G01N 27/26
USPC 205/775; 204/400

(57) ABSTRACT

A method for electrochemically detecting an analyte contained in a sample using a working electrode and a counter electrode, comprising: allowing an electrolyte solution which contains a solution prepared by dissolving an imidazolium iodide compound in a protic solvent to be into contact with the working electrode and the counter electrode; and electrochemically detecting the analyte contained in the sample in the presence of the electrolyte solution is disclosed. A kit to be used for the method for electrochemically detecting an analyte is also disclosed.

### BACKGROUND OF THE INVENTION

1. Field of the Invention

The present invention relates to a method for electrochemically detecting an analyte. More particularly, it relates to a method for electrochemically detecting an analyte, which is useful for detecting and quantifying analytes such as nucleic acids and proteins as well as clinically examining and diagnosing diseases using these methods, and an electrolyte solution used for the method.

2. Background

Clinical examination and diagnosis of diseases are performed by detecting analytes such as genes and proteins related to the diseases which are contained in biological samples. Examples of the method for detecting an analyte include immunochromatography, latex agglutination, enzyme immunoassay, chemiluminescent immunoassay, and polymerase chain reaction (PCR). However, it is desired that these detection methods are improved from any of the viewpoints of simplicity, rapidity or running cost.

Thus, a method for electrochemically detecting an analyte, comprising detecting an analyte using a sensitizing dye in which the photocurrent is generated by photoexcitation has been suggested (refer to, for example, U.S. Patent Application Publication No. 2009/0294305). In the method described in U.S. Patent Application Publication No. 2009/0294305, a sensitizing dye is first bound to an analyte and the analyte is captured on a working electrode via a probe. Next, the analyte is detected based on the photocurrent generated by irradiating the sensitizing dye on the working electrode with light. In the method described in U.S. Patent Application Publication No. 2009/0294305, when the sensitizing dye is photoexcited to detect the photocurrent, an electrolyte solution which contains an electrolyte such as iodide except for 12 and at least one solvent selected from an aprotic solvent and a protic solvent is used as the electrolyte solution.

From the viewpoint of reducing environmental loads, there has been recently a need for an electrolyte solution prepared without using an aprotic solvent having a large environmental load.

A process of detecting the photocurrent using a protic solvent as a solvent of the electrolyte solution is described in U.S. Patent Application Publication No. 2009/0294305. However, in the electrolyte solution described in U.S. Patent Application Publication No. 2009/0294305, the photocurrent when using the protic solvent as the solvent is significantly decreased as compared with the photocurrent when using the aprotic solvent as the solvent. Therefore, there is a need for a method or means capable of detecting photocurrents with higher detection sensitivity.

### SUMMARY OF THE INVENTION

The scope of the present invention is defined solely by the appended claims, and is not affected to any degree by the statements within this summary.

A first aspect of the present invention is a method for electrochemically detecting an analyte contained in a sample using a working electrode and a counter electrode, comprising:

allowing an electrolyte solution which contains a solution prepared by dissolving an imidazolium iodide compound in a protic solvent to be into contact with the working electrode and the counter electrode; and

electrochemically detecting the analyte contained in the sample in the presence of the electrolyte solution.

A second aspect of the present invention is a kit to be used for the method for electrochemically detecting an analyte, comprising:

an electrolyte solution which is used for the method for electrochemically detecting an analyte contained in a sample in the presence of an electrolyte solution using a working electrode and a counter electrode; and

a labeling substance from which electrons originate via photoexcitation;

wherein the electrolyte solution is a solution prepared by dissolving an imidazolium iodide compound in a protic solvent.

### BRIEF DESCRIPTION OF THE DRAWINGS

FIG. 1 is a perspective view showing a detector which is used for the method for electrochemically detecting an analyte according to First Embodiment of the present invention;

FIG. 2 is a block diagram showing the configuration of the detector shown in FIG. 1;

FIG. 3 is a perspective view showing a detection chip which is used for the method for electrochemically detecting an analyte according to First Embodiment of the present invention;

FIG. 4 (A) is a cross-sectional view in an AA line of the detection chip shown in FIG. 3;

FIG. 4 (B) is a perspective view of the upper substrate of the detection chip shown in FIG. 3 when viewed from the lower surface side;

FIG. 4 (C) is a perspective view of the lower substrate of the detection chip shown in FIG. 3 when viewed from the upper surface side;

FIG. 5 is a cross sectional explanatory view showing an example of a portion including electrodes in the detection chip to be used in the method for electrochemically detecting an analyte according to First Embodiment of the present invention;

FIGS. 6(A) to 6(D) are process explanatory views showing the procedure of the method for electrochemically detecting an analyte according to First Embodiment of the present invention; FIG. 6(A) shows the process of supplying a sample; FIG. 6(B) shows the process of trapping an analyte; FIG. 6(C) shows the labeling process; and FIG. 6(D) shows the detection process;

FIG. 7 is a graph showing the examined results of the photocurrent values of the signals derived from the thiol group-containing DNA and the photocurrent values of noise from non-specific adsorption when the electrolyte solution obtained in Example 1 and the electrolyte solution obtained in Comparative Example 1 were used in Test example 1;

FIG. 8 is a graph showing the examined results of the photocurrent values of the IL-6-derived signals and the photocurrent values of noise from non-specific adsorption when the electrolyte solution obtained in Example 1 and the electrolyte solution obtained in Comparative Example 1 were used in Test example 2;

FIG. 9 is a graph showing the examined results of the photocurrent values of the signals derived from the thiol group-containing DNA when the electrolyte solutions obtained in Examples 1 to 6 were used in Test example 3;

FIG. 10 is a graph showing the examined results of the photocurrent values of the signals derived from the thiol group-containing DNA when the electrolyte solutions obtained in Examples 7 to 14 and Comparative Examples 2 to 6 were used; and

FIG. 11 is a graph showing the examined results of the photocurrent S/N values when the electrolyte solutions obtained in Examples 7 to 14 and Comparative Examples 2 to 6 were used.

### DETAILED DESCRIPTION OF PREFERRED EMBODIMENTS

### [Configuration of Detector]

First, an example of the detector which is used for the method for electrochemically detecting an analyte according to First Embodiment of the present invention will be explained with reference to the attached drawings.

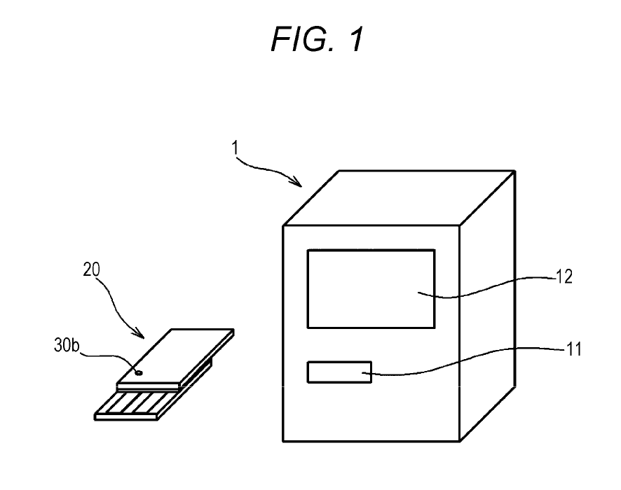

FIG. 1 is a perspective view showing a detector which is used for the method for electrochemically detecting an analyte according to First Embodiment of the present invention. A detector 1 is used for the detection method which uses a photochemically active substance as a labeling substance.

The detector 1 includes a chip insertion unit 11 into which a detection chip 20 is inserted and a display 12 which displays the detection results.

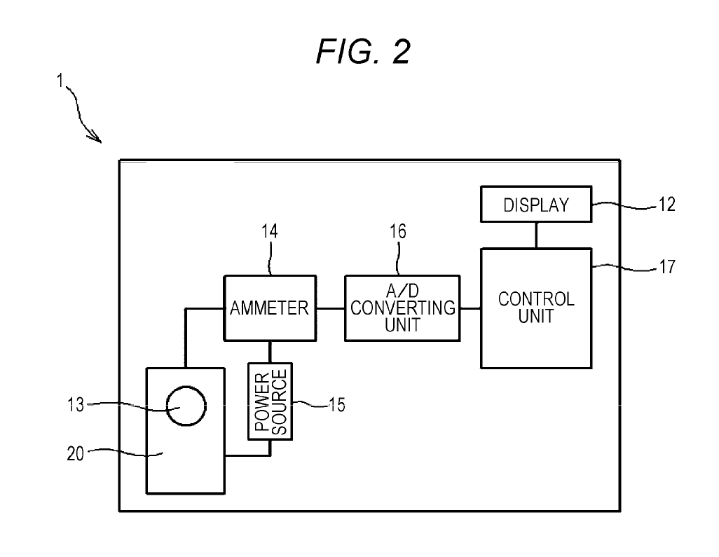

FIG. 2 is a block diagram showing the configuration of the detector shown in FIG. 1. The detector 1 includes a light source 13, an ammeter 14, a power source 15, an A/D converting unit 16, a control unit 17, and a display 12.

The light source 13 irradiates a labeling substance present on the working electrode of the detection chip 20 with light to excite the labeling substance. The light source 13 may be a light source which generates excitation light. The ammeter 14 measures an electric current which flows through the detection chip 20 due to electrons released from the excited labeling substance. The power source 15 applies a predetermined potential to an electrode formed in the detection chip 20. The A/D converting unit 16 digitally converts the photocurrent values measured by the ammeter 14. The control unit 17 is configured to include a Central Processing Unit (CPU), a Read Only Memory (ROM), a Random Access Memory (RAM), or the like. The control unit 17 controls the operation of the display 12, the light source 13, the ammeter 14, and the power source 15. The control unit 17 estimates the amount of the labeling substance from the photocurrent value which has been digitally converted by the A/D converting unit 16 based on a calibration curve indicating a relationship between a photocurrent value created in advance and the amount of the labeling substance and calculates the amount of the analyte. The display 12 displays information such as the amount of the analyte which has been estimated by the control unit 17.

### [Configuration of Detection Chip]

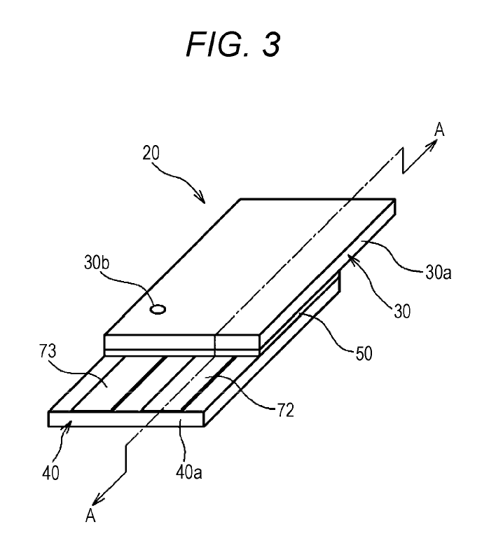

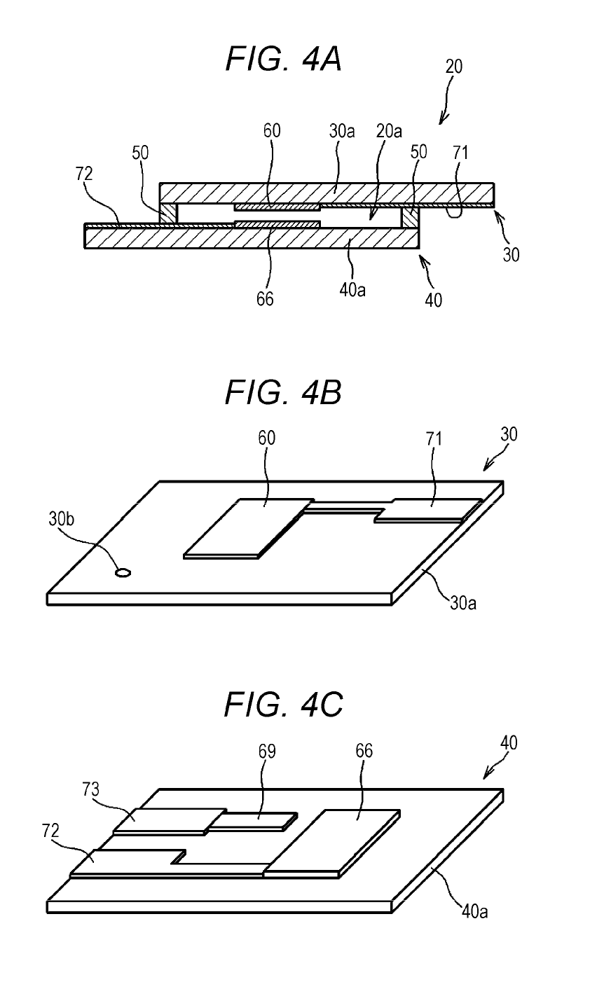

Next, the configuration of the detection chip 20 which is used for the method for electrochemically detecting an analyte according to First Embodiment of the present invention will be described. FIG. 3 is a perspective view showing the detection chip which is used for the method for electrochemically detecting an analyte according to First Embodiment of the present invention. FIG. 4 (A) is a cross-sectional view in an AA line of the detection chip shown in FIG. 3, FIG. 4 (B) is a perspective view of the upper substrate of the detection chip shown in FIG. 3 when viewed from the lower surface side, and FIG. 4 (C) is a perspective view of the lower substrate of the detection chip shown in FIG. 3 when viewed from the upper surface side.

The detection chip 20 includes an upper substrate 30, a lower substrate 40 formed on the lower side of the upper substrate 30, and a spacing member 50 sandwiched between the upper substrate 30 and the lower substrate 40. In the detection chip 20, the upper substrate 30 and the lower substrate 40 are arranged so as to be overlapped at one side portion. The spacing member 50 is intervened in a portion where the upper substrate 30 and the lower substrate 40 are overlapped.

The upper substrate 30 includes a substrate body 30a and a working electrode 60 as shown in FIG. 4 (B). A sample inlet 30b for injecting a sample containing an analyte into the inside is formed in the substrate body 30a. The working electrode 60 and an electrode lead 71 connected to the working electrode 60 are formed on the surface of the substrate body 30a. In the upper substrate 30, the working electrode 60 is disposed at one side portion [the left side in FIG. 4 (B)] of the substrate body 30a. The electrode lead 71 is extended from the working electrode 60 to the other side portion of the substrate body 30a [the right side in FIG. 4 (B)]. The sample inlet 30b is formed at an inner side than a portion where the spacing member 50 is interposed in the substrate body 30a.

In the present embodiment, the substrate body 30a is formed into a rectangular shape. The shape of the substrate body 30a is not particularly limited and it may be polygonal, discoid or the like.

Examples of the material for forming the substrate body 30a include inorganic materials such as glass; plastics such as polyethylene terephthalate and polyimide resin; and metal. However, the present invention is not limited only thereto. The thickness of the substrate body 30a is preferably from 0.01 to 1 mm, more preferably from 0.1 to 0.7 mm, still more preferably about 0.5 mm from the viewpoint of ensuring sufficient durability. The size of the substrate body 30a is usually about 20 mm×20 mm and it varies depending on the number of items on the premise of detection of various types of analytes (many items).

The lower substrate 40 includes a substrate body 40a, a counter electrode 66, and a reference electrode 69 as shown in FIG. 4 (C). The substrate body 40a is formed into a rectangular shape with almost the same size as the substrate body 30a of the upper substrate 30. The substrate body 40a does not necessarily have the same size as the substrate body 30a.

Examples of the material for forming the substrate body 40a include inorganic materials such as glass; plastics such as polyethylene terephthalate and polyimide resin; and metal. However, the present invention is not limited only thereto. Among them, the glass is preferred from the viewpoint of ensuring heat resistance, durability, and smoothness and reducing the cost required for the materials. The thickness and size of the substrate body 40a are the same as those of the substrate body 30a of the upper substrate 30.

The counter electrode 66, an electrode lead 72 connected to the counter electrode 66, the reference electrode 69, and an electrode lead 73 connected to the reference electrode 69 are formed on the surface of the substrate body 40a. In the lower substrate 40, the counter electrode 66 is disposed at one side portion of the substrate body 40a [the right side in FIG. 4 (C)]. The reference electrode 69 is disposed at a position opposed to the counter electrode 66 on the substrate body 40a. The electrode lead 72 of the counter electrode 66 and the electrode lead 73 of the reference electrode 69 are extended from one side portion of the substrate body 40a [the right side in FIG. 4 (C)] to the other side portion [the left side in FIG. 4 (C)]. The electrode lead 72 of the counter electrode 66 and the electrode lead 73 of the reference electrode 69 are disposed at the other side portion of the substrate body 40a [the left side in FIG. 4 (C)] so as to be parallel to each other. The electrode lead 72 and 73 are protruded from the portion where the upper substrate 30 and the lower substrate 40 are overlapped and exposed to the outside [see FIGS. 3 and 4 (A)]. The substrate body 30a and the substrate body 40a are desirably substrate bodies formed of a material having permeability when light is emitted so as to transmit the substrate body. In this case, of the substrate body 30a and the substrate body 40a, the substrate body to be irradiated with light may be formed from the material having permeability.

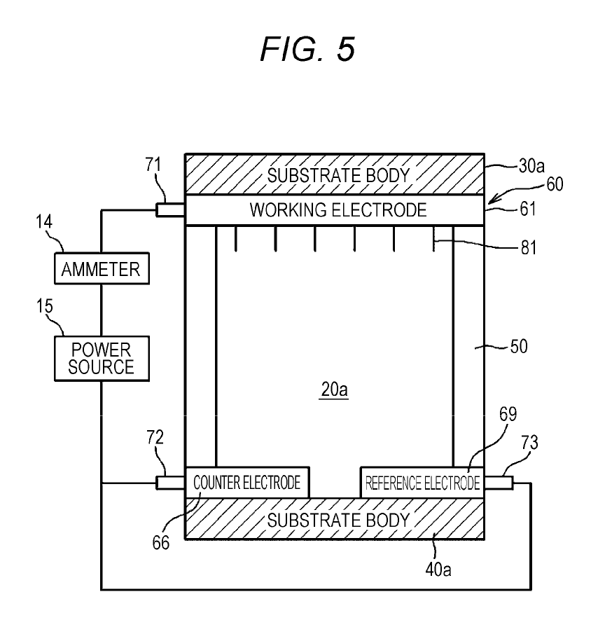

Subsequently, the working electrode 60, the counter electrode 66, and the reference electrode 69 will be explained in detail. FIG. 5 is a cross sectional explanatory view showing an example of a portion including electrodes in the detection chip to be used in the method for electrochemically detecting an analyte according to First Embodiment of the present invention. The working electrode 60 is formed into a nearly rectangular shape. The working electrode 60 is configured to include a working electrode body 61 formed on the substrate body 30a and trapping substances 81 immobilized on the working electrode body 61 as shown in FIG. 5. The electrode lead 71 is connected to the working electrode body 61.

The working electrode body 61 is formed of a semiconductor which receives electrons from the analyte generated by irradiation with excitation light. The semiconductor functions as a conductive body and an electron acceptor. The semiconductor may be a substance which may have an energy level capable of injecting electrons from the analyte excited by light. Here, the term “energy level capable of injecting electrons from the analyte excited by light” means a conduction band. That is, the semiconductor may have an energy ranking lower than an energy level of lowest unoccupied molecular orbital (LUMO) of the labeling substance. Examples of the semiconductor include element semiconductors such as silicon and germanium; oxide semiconductors containing oxides such as titanium, tin, zinc, iron, tungsten, zirconium, hafnium, strontium, indium, cerium, yttrium, lanthanum, vanadium, niobium, and tantalum; perovskite-type semiconductors such as strontium titanate, calcium titanate, sodium titanate, vanadium titanate, and potassium niobate; sulfide semiconductors containing sulfides such as cadmium, zinc, lead, silver, antimony, and bismuth; semiconductors containing nitrides such as gallium and titanium; semiconductors composed of selenides such as cadmium and lead (e.g. cadmium selenide); semiconductors containing telluride of cadmium; semiconductors composed of phosphorus compounds such as zinc, gallium, indium, and cadmium; and semiconductors containing compounds such as gallium arsenide, copper-indium selenide, and copper-indium sulfide; and compound semiconductors such as carbon or organic semiconductors. However, the present invention is not limited only thereto. The semiconductors may be either intrinsic semiconductors or extrinsic semiconductors. Among the above semiconductors, the oxide semiconductors are preferred. Among the intrinsic semiconductors of the oxide semiconductors, titanium oxide, zinc oxide, tin oxide, niobium oxide, indium oxide, tungsten oxide, tantalum oxide, and strontium titanate are preferred. Among the extrinsic semiconductors of the oxide semiconductors, indium oxide (ITO) which includes tin as a dopant and tin oxide (FTO) which includes fluorine as a dopant are preferred. The thickness of the working electrode is usually from 0.1 to 1 μm, preferably from 0.1 to 200 nm, more preferably from 0.1 to 10 nm.

In the present invention, the working electrode body 61 may be formed of a semiconductor layer and a conductive layer. In this case, the electrode lead 71 of the working electrode body 61 is connected to the conductive layer.

A semiconductor for forming the semiconductor layer is the same as the above-described semiconductor. In this case, the thickness of the semiconductor layer is preferably from 0.1 to 100 nm, more preferably from 0.1 to 10 nm.

The conductive layer is formed of a conductive material. Examples of the conductive material include metals such as gold, silver, copper, carbon, platinum, palladium, chromium, aluminum, and nickel or an alloy containing at least one of those metals; indium oxide-based materials such as indium oxide and ITO; tin oxide-based materials such as tin oxide, tin oxide (ATO) which includes antimony as a dopant, and tin oxide-based materials such as FTO; titanium-based materials such as titanium, titanium oxide, and titanium nitride; and carbon-based materials such as graphite, glassy carbon, pyrolytic graphite, carbon paste, and carbon fiber. However, the present invention is not limited only thereto. The thickness of the conductive layer is preferably from 1 to 1000 nm, more preferably from 1 to 200 nm, still more preferably from 1 to 100 nm. The thickness of the conductive layer is desirably a film thickness capable of ensuring the conductivity and making the photocurrent generated from the electrode a minimum photocurrent. The conductive material may be a composite base material in which a conductive material layer composed of a material having conductivity is formed on the surface of a nonconductive base material composed of nonconductive substances such as glass and plastics. The shape of the conductive material layer may be filmy or spot-like. Examples of the material for forming the conductive material layer include ITO, ATO, and FTO. However, the present invention is not limited only thereto. The conductive layer is formed, for example, by a film formation method according to the type of the material for forming the conductive layer.

The trapping substances 81 are immobilized on the surface of the working electrode body 61 [see FIG. 5]. A trapping substance 81 is a substance which traps the analyte. Accordingly, the analyte is allowed to be present near the working electrode body 61. The trapping substance 81 can be appropriately selected depending on the type of the analyte. Examples of the trapping substance 81 include nucleic acids, proteins, peptides, sugar chains, antibodies, and nanostructures with specific recognition ability. However, the present invention is not limited only thereto.

The counter electrode 66 is formed on the substrate body 40a as shown in FIG. 5. The counter electrode 66 is composed of a thin film of a conductive material. Examples of the conductive material include metals such as gold, silver, copper, carbon, platinum, palladium, chromium, aluminum, and nickel or an alloy containing at least one of those metals; conductive ceramics such as ITO and indium oxide; metal oxides such as ATO and FTO; and titanium compounds such as titanium, titanium oxide, and titanium nitride. However, the present invention is not limited only thereto. The thickness of the thin film composed of a conductive material is preferably from 1 to 1000 nm, more preferably from 10 to 200 nm.

The reference electrode 69 is formed on the substrate body 40a as shown in FIG. 5. The reference electrode 69 is composed of a thin film of a conductive material. Examples of the conductive material include metals such as gold, silver, copper, carbon, platinum, palladium, chromium, aluminum, and nickel or an alloy containing at least one of those metals; conductive ceramics such as ITO and indium oxide; metal oxides such as ATO and FTO; and titanium compounds such as titanium, titanium oxide, and titanium nitride. However, the present invention is not limited only thereto. The thickness of the thin film composed of a conductive material is preferably from 1 to 1000 nm, more preferably from 10 to 200 nm. Although the reference electrode 69 is formed in the present embodiment, it is not necessary to form the reference electrode 69 in the present invention. Depending on the type and film thickness of the electrode to be used for the counter electrode 66, when a small current (e.g. 1 μA or less) to be less affected by the voltage drop influences is measured, the counter electrode 66 may serve as the reference electrode 69. On the other hand, when measuring a large current, it is preferable to form the reference electrode 69 from the viewpoint of suppressing voltage drop influences and stabilizing a voltage to be applied to the working electrode 60.

Subsequently, the spacing member 50 will be explained. The spacing member 50 is formed into a rectangular-circular shape and is composed of silicone rubber which is an insulating material. The spacing member 50 is arranged so as to surround the working electrode 60, the counter electrode 66, and the reference electrode 69 [see FIGS. 4 (A) and 5]. A space corresponding to the thickness of the spacing member 50 is formed between the upper substrate 30 and the lower substrate 40. Thus, a space 20a for housing a sample and an electrolytic solution is formed among the electrodes (the working electrode 60, the counter electrode 66, and the reference electrode 69) [see FIGS. 4 (A) and 5]. The thickness of the spacing member 50 is usually from 0.2 to 300 μm. In the present invention, in place of silicone rubber, a double-sided plastic tape such as a polyester film can also be used as the material for forming the spacing member 50.

In the present invention, the working electrode 60, the counter electrode 66, and the reference electrode 69 may be arranged in a frame of the spacing member 50 so as not to bring the electrodes into contact with other electrodes. Therefore, the working electrode 60, the counter electrode 66, and the reference electrode 69 may be formed on the same substrate body. In the present invention, the counter electrode 66 and the reference electrode 69 may not be a film-like electrode formed on the substrate body. In this case, at least one of the counter electrode 66 and the reference electrodes 69 may be formed on the member body of the spacing member 50. The electrodes other than the electrode formed on the member body of the spacing member 50 may be formed on either the upper substrate 30 or the lower substrate 40.

### [Electrolyte Solution]

Subsequently, an electrolyte solution which is used for the method for electrochemically detecting an analyte according to First Embodiment of the present invention will be described. The present invention also encompasses the electrolyte solution.

The electrolyte solution of the present invention is comprised of a protic solvent solution of an imidazolium iodide compound. The electrolyte solution is prepared by dissolving the imidazolium iodide compound in the protic solvent solution.

As the imidazolium iodide compound, for example,

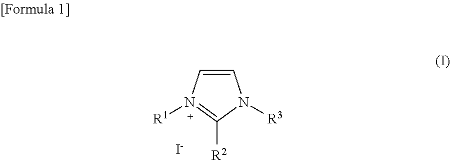

an imidazolium iodide compound represented by Formula (I) (wherein R¹, R², and R³ each independently represent a hydrogen atom, a monovalent hydrocarbon group having 1 to 8 carbon atoms or an alkoxy group having 1 to 8 carbon atoms.) is listed. However, the present invention is not limited only thereto. Among these imidazolium iodide compounds, the imidazolium iodide compound represented by Formula (I) is preferred.

In Formula (I), R¹, R², and R³ each independently represent a hydrogen atom, a monovalent hydrocarbon group having 1 to 8 carbon atoms or an alkoxy group having 1 to 8 carbon atoms.

Examples of the monovalent hydrocarbon group having 1 to 8 carbon atoms in R¹, R², and R³ include an alkyl group having 1 to 8 carbon atoms, an alkenyl group having 2 to 8 carbon atoms, an alkynyl group having 2 to 8 carbon atoms, and an aryl group having 6 to 8 carbon atoms. However, the present invention is not limited only thereto. Among these monovalent hydrocarbon groups having 1 to 8 carbon atoms, the alkyl group having 1 to 8 carbon atoms and the alkenyl group having 2 to 8 carbon atoms are preferred from the viewpoint of ensuring a high S/N ratio and detecting an analyte with high sensitivity.

Examples of the alkyl group having 1 to 8 carbon atoms include alkyl groups having a straight- or branched-chain having 1 to 8 carbon atoms such as a methyl group, an ethyl group, an n-propyl group, an isopropyl group, an n-butyl group, an iso-butyl group, a sec-butyl group, a tert-butyl group, an n-pentyl group, an isopentyl group, a neopentyl group, a tert-pentyl group, a hexyl group, a heptyl group, and an octyl group; and alicyclic alkyl groups having 3 to 8 carbon atoms such as a cyclopropyl group, a cyclobutyl group, a cyclopentyl group, a cyclohexyl group, a cycloheptyl group, and a cyclo octyl group. However, the present invention is not limited only thereto. Among these alkyl groups having 1 to 8 carbon atoms, the methyl group, ethyl group, propyl group, butyl group, and hexyl group are preferred from the viewpoint of ensuring a high S/N ratio and detecting an analyte with high sensitivity.

Examples of the alkenyl group having 2 to 8 carbon atoms include a vinyl group, an allyl group, an isopropenyl group, a methylvinyl group, a 3-butenyl group, a 2-methyl-1-butenyl group, a 3-methyl-1-butenyl group, a 2-methyl-3-butenyl group, a 3-methyl-3-butenyl group, a pentenyl group, a hexenyl group, a cyclo propenyl group, a cyclo butenyl group, a cyclopentenyl group, and a cyclohexenyl group. However, the present invention is not limited only thereto. Among these alkenyl groups having 2 to 6 carbon atoms, the allyl group is preferred from the viewpoint of ensuring a high S/N ratio and detecting an analyte with high sensitivity.

Examples of the alkynyl group having 2 to 8 carbon atoms include an ethynyl group, a propynyl group, a butynyl group, a pentynyl group, and a hexynil group. However, the present invention is not limited only thereto. Among these alkynyl groups having 2 to 8 carbon atoms, the ethynyl, propynyl, and hexynil groups are preferred from the viewpoint of ensuring a high S/N ratio and detecting an analyte with high sensitivity.

Examples of the alkoxy group having 1 to 8 carbon atoms include a methoxy group, an ethoxy group, an n-propoxy group, an isopropoxy group, an n-butoxy group, an isobutoxy group, a sec-butoxy group, a tert-butoxy group, a pentyloxy group, a hexyloxy group, a heptyloxy group, and an octyloxy group. However, the present invention is not limited only thereto. Among these alkoxy groups having 1 to 8 carbon atoms, the methoxy, ethoxy, n-propoxy, and hexyloxy groups are preferred from the viewpoint of ensuring a high S/N ratio and detecting an analyte with high sensitivity.

From the viewpoint of ensuring a high S/N ratio and detecting an analyte with high sensitivity, among the imidazolium iodide compounds represented by Formula (I), an imidazolium iodide compound wherein one of R¹ to R³ or two of R¹ to R³ represent a monovalent hydrocarbon group having 1 to 8 carbon atoms is preferred. An imidazolium iodide compound wherein one of R¹ to R³ or two of R¹ to R³ represent an alkyl group having 1 to 8 carbon atoms or an alkenyl group having 2 to 8 carbon atoms is more preferred. An imidazolium iodide compound wherein one of R¹ to R³ or two of R¹ to R³ represent a group selected from the group consisting of a methyl group, an ethyl group, a propyl group, a butyl group, a hexyl group, and an allyl group is still more preferred. Examples of the imidazolium iodide compound wherein one of R¹ to R³ or two of R¹ to R³ represent a monovalent hydrocarbon group having 1 to 8 carbon atoms include 1,3-dimethylimidazolium iodide, 1-ethyl-3-methylimidazolium iodide, 1-methyl-3-propylimidazolium iodide, 1-propyl-3-methylimidazolium iodide, 1-butyl-3-methylimidazolium iodide, 1-methyl-3-pentylimidazolium iodide, 1-hexyl-3-methylimidazolium iodide, 1-heptyl-3-methylimidazolium iodide, 1-methyl-3-octylimidazolium iodide, 1-ethyl-3-propylimidazolium iodide, 1-butyl-3-ethylimidazolium iodide, and 1-allyl-3-methylimidazolium iodide. However, the present invention is not limited only thereto.

Among the imidazolium iodide compounds represented by Formula (I), an imidazolium iodide compound, wherein a value calculated by Formula (II):

[the number of carbon atoms of a hydrocarbon group with the greatest number of carbon atoms/the number of carbon atoms of other hydrocarbon groups]

in Formula (I) is 3 or less, may be selected from the viewpoint of ensuring a high S/N ratio and detecting an analyte with high sensitivity. Specific examples of the imidazolium iodide compound, wherein a value calculated by Formula (II) is 3 or less, include 1-ethyl-3-methylimidazolium iodide, 1-methyl-3-propylimidazolium iodide, 1-propyl-3-methylimidazolium iodide, 1-propyl-2,3-dimethylimidazolium iodide, 1-butyl-2,3-dimethylimidazolium iodide, and 1-hexyl-2,3-dimethylimidazolium iodide. However, the present invention is not limited only thereto.

An imidazolium iodide compound, wherein in Formula (I), one of R¹ to R³ has a hexyl group, is preferred from the viewpoint of ensuring a high S/N ratio and detecting an analyte with high sensitivity.

Specific examples of the imidazolium iodide compound represented by Formula (I) include 1,3-dimethylimidazolium iodide, 1-ethyl-3-methylimidazolium iodide, 1-methyl-3-propylimidazolium iodide, 1-propyl-3-methylimidazolium iodide, 1-butyl-3-methylimidazolium iodide, 1-methyl-3-pentylimidazolium iodide, 1-hexyl-3-methylimidazolium iodide, 1-heptyl-3-methylimidazolium iodide, 1-methyl-3-octylimidazolium iodide, 1-ethyl-3-propylimidazolium iodide, 1-butyl-3-ethylimidazolium iodide, 1-allyl-3-methylimidazolium iodide, 1-propyl-2,3-dimethylimidazolium iodide, 1-butyl-2,3-dimethylimidazolium iodide, and 1-hexyl-2,3-dimethylimidazolium iodide. However, the present invention is not limited only thereto. From the viewpoint of ensuring a high S/N ratio and detecting an analyte with high sensitivity, among these imidazolium iodide compounds represented by Formula (I), 1-ethyl-3-methylimidazolium iodide, 1-methyl-3-propylimidazolium iodide, 1-propyl-3-methylimidazolium iodide, 1-butyl-3-methylimidazolium iodide, 1-hexyl-3-methylimidazolium iodide, 1-allyl-3-methylimidazolium iodide, 1-propyl-2,3-dimethylimidazolium iodide, 1-butyl-2,3-dimethylimidazolium iodide, and 1-hexyl-2,3-dimethylimidazolium iodide are preferred. 1-ethyl-3-methylimidazolium iodide, 1-propyl-3-methylimidazolium iodide, 1-hexyl-3-methylimidazolium iodide, and 1-propyl-2,3-dimethylimidazolium iodide are more preferred. 1-hexyl-3-methylimidazolium iodide is still more preferred. These imidazolium iodides may be used alone or in combination with two or more.

Examples of the protic solvent include water and a solution containing a buffer component. However, the present invention is not limited only thereto.

The electrolyte solution is usually dissociated into imidazolium cations and iodine anions. The concentration of the imidazolium cations in the electrolyte solution is preferably 0.01 mol/L or more, more preferably 0.1 mol/L or more from the viewpoint of obtaining a sufficient signal. It is preferably 20 mol/L or less, more preferably 10 mol/L or less from the viewpoint of obtaining sufficient fluidity of the electrolyte solution.

The electrolyte solution is prepared by dissolving an imidazolium iodide compound in a protic solvent solution. The term “dissolving” means that the imidazolium iodide compound is dissolved in the protic solvent within the range of 5 to 50° C. The blending amount of the imidazolium iodide compound per 100 mass parts of the protic solvent is preferably 0.01 part by mass or more, more preferably 0.1 part by mass or more from the viewpoint of obtaining a sufficient signal. It is preferably 20 parts by mass or less, more preferably 10 parts by mass or less from the viewpoint of obtaining sufficient fluidity of the electrolyte solution.

### [Method for Electrochemically Detecting Analyte]

Subsequently, the procedure of the method for electrochemically detecting an analyte of the present invention will be described in detail.

The method for electrochemically detecting an analyte of the present invention is a method for electrochemically detecting an analyte contained in a sample in the presence of an electrolyte solution using a working electrode and a counter electrode, wherein the electrolyte solution is the electrolyte solution of the present invention which contains a solution prepared by dissolving an imidazolium iodide compound in a protic solvent. In the method for electrochemically detecting an analyte of the present invention, the electrolyte solution of the present invention is used. Thus, it is possible to ensure high detection sensitivity equal to that in the case of using an aprotic solvent-based electrolyte solution by using a protic solvent without using an aprotic solvent having a large environmental load. Further, in the method comprising: capturing an analyte on a working electrode using the physiological function of DNA or proteins (i.e., analytes); and electrochemically detecting the trapped analyte, a solution containing a buffer component suitable for maintaining the physiological function of DNA or proteins is used in order to capture the analyte on the working electrode. Therefore, in the case of using an electrolyte solution containing an aprotic solvent when detecting the photocurrents, it is necessary to replace the solution used for trapping the analyte with an aprotic solvent. On the other hand, in the method for electrochemically detecting an analyte of the present invention, the electrolyte solution of the present invention is used, and thus the solvent does not have to be replaced during the processes of capturing the analyte on the working electrode and measuring the photocurrents.

The method for electrochemically detecting an analyte of the present invention includes:

(1) allowing a labeling substance from which electrons originate via photoexcitation to be present on the working electrode in an amount corresponding to the amount of the analyte in the sample;

(2) irradiating the labeling substance with light in a state where the electrolyte solution is in contact with the working electrode and the counter electrode; and

(3) measuring the electric current which flows between the working electrode and the counter electrode due to the movement of electrons from the labeling substance excited by light irradiation. In this case, the method for electrochemically detecting an analyte of the present invention may be a method in which the step (1) comprises the steps of

(A-1) bringing a working electrode having a probe capable of trapping an analyte immobilized thereon into contact with a sample containing the analyte so as to capture the analyte on the working electrode; and

(A-2) introducing a labeling substance into the analyte captured on the working electrode, or may be a method in which the working electrode is a working electrode having a probe capable of trapping an analyte immobilized thereon, and the step (1) comprises the steps of

(B-1) introducing a labeling substance into an analyte contained in a sample; and

(B-2) bringing the working electrode into contact with the sample so as to capture the analyte on the probe on the working electrode.

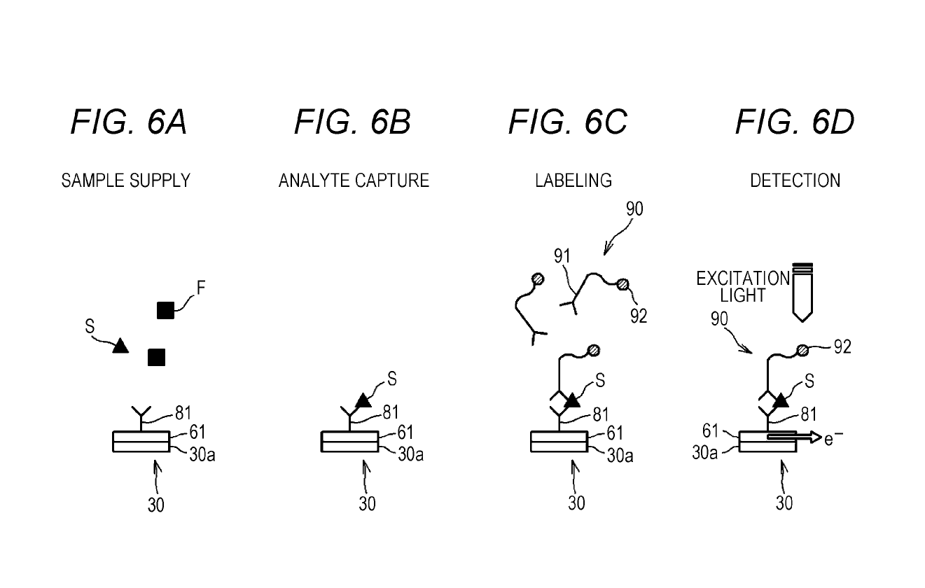

Hereinafter, the procedure of the method for electrochemically detecting an analyte according to First Embodiment of the present invention will be described based on the attached drawings. FIG. 6 is a process explanatory view showing the procedure of the method for electrochemically detecting an analyte according to First Embodiment of the present invention.

A user injects a sample containing the analyte S through the sample inlet 30b of the detection chip 20 [see the process of supplying a sample in FIG. 6(A)]. Thus, the analyte in the sample is trapped by the trapping substance 81 on the working electrode body 61 of the upper substrate 30 constituting the detection chip 20 [see the process of trapping an analyte in FIG. 6 (B)]. In this case, substances (contaminants F) other than the analyte S in the sample are not trapped by the trapping substance 81.

The trapping substance 81 can be suitably selected depending on the type of the analyte S. For example, when the analyte S is a nucleic acid, a nucleic acid probe hybridizing to the nucleic acid, an antibody to the nucleic acid, a protein binding to the nucleic acid or the like can be used as the trapping substance 81. When the analyte S is a protein or peptide, an antibody to the protein or peptide can be used as the trapping substance 81.

The process of trapping an analyte by the trapping substance 81 can be performed for example, under conditions where the trapping substance 81 is bound to the analyte. The conditions where the trapping substance 81 is bound to the analyte can be suitably selected depending on the type of the analyte. For example, when the analyte is a nucleic acid and the trapping substance 81 is a nucleic acid probe to be hybridized with the nucleic acid, the process of trapping an analyte can be performed in the presence of a hybridization buffer. When the analyte is a nucleic acid, protein or peptide and the trapping substance 81 is an antibody to nucleic acid, an antibody to protein or an antibody to peptide, the process of trapping an analyte can be performed in a solution suitable for performing an antigen-antibody reaction, such as phosphate buffered saline, a HEPES buffer, a PIPES buffer or a Tris buffer. When the analyte is a ligand and the trapping substance 81 is a receptor to ligand, or when the analyte is a receptor and the trapping substance 81 is a ligand to receptor, the process of trapping an analyte can be performed in a solution suitable for binding the ligand to the receptor.

Then, the user injects the label binding substance 90 into the detection chip 20 from the sample inlet 30b to allow the label binding substance 90 to be bound to the analyte S trapped by the trapping substance 81 on the working electrode body 61 [see the labeling process in FIG. 6 (C)]. In the labeling process, a complex containing the trapping substance 81 on the working electrode body 61, the analyte S, and the label binding substance 90 is formed.

The label binding substance 90 is formed of a binding substance 91 to be bound to the analyte S and a labeling substance 92.

The binding substance 91 may be a substance which binds to a position or site in the analyte S, which is different from that of the trapping substance 81. The binding substance 91 is suitably selected depending on the type of the analyte S. For example, when the analyte S is a nucleic acid, a nucleic acid probe hybridizing to the nucleic acid, an antibody to the nucleic acid, a protein binding to the nucleic acid or the like can be used as the binding substance 91. When the analyte S is a protein or peptide, an antibody to the protein or peptide can be used as the binding substance 91.

The labeling substance 92 is a substance which becomes in an excited state when irradiated with light and releases electrons. As the labeling substance 92, at least one selected from the group consisting of a metal complex, an organic phosphor, a quantum dot, and an inorganic phosphor can be used.

Specific examples of the labeling substance include metal phthalocyanine dyes, a ruthenium complex, an osmium complex, an iron complex, a zinc complex, 9-phenylxanthene-based dyes, cyanine-based dyes, metallocyanine dyes, xanthene-based dyes, triphenylmethane-based dyes, acridine-based dyes, oxazine-based dyes, coumarin-based dyes, merocyanine-based dyes, rhodacyanine-based dyes, polymethine-based dyes, porphyrin-based dyes, phthalocyanine-based dyes, rhodamine-based dyes, xanthene-based dyes, chlorophyl-based dyes, eosine-based dyes, mercurochrome-based dyes, indigo-based dyes, BODIPY-based dyes, CALFluor-based dyes, Oregon green-based dyes, Rhodol green, Texas red, Cascade blue, nucleic acids (DNA and RNA), cadmium selenide, cadmium telluride, Ln₂O₃:Re, Ln₂O₂S:Re, ZnO, CaWO₄, MO.xAl₂O₃:Eu, Zn₂SiO₄:Mn, LaPO₄:Ce, Tb, Cy3, Cy3.5, Cy5, Cy5.5, Cy7, Cy7.5, and Cy9 (all products are manufactured by Amersham Biosciences K.K.); Alexa Fluor 355, Alexa Fluor 405, Alexa Fluor 430, Alexa Fluor 488, Alexa Fluor 532, Alexa Fluor 546, Alexa Fluor 555, Alexa Fluor 568, Alexa Fluor 594, Alexa Fluor 633, Alexa Fluor 647, Alexa Fluor 660, Alexa Fluor 680, Alexa Fluor 700, Alexa Fluor 750 and Alexa Fluor 790 (all products are manufactured by Molecular Probes, Inc.); DY-610, DY-615, DY-630, DY-631, DY-633, DY-635, DY-636, EVOblue10, EVOblue30, DY-647, DY-650, DY-651, DY-800, DYQ-660, and DYQ-661 (all products are manufactured by Dyomics); Atto425, Atto465, Atto488, Atto495, Atto520, Atto532, Atto550, Atto565, Atto590, Atto594, Atto610, Atto611X, Atto620, Atto633, Atto635, Atto637, Atto647, Atto655, Atto680, Atto700, Atto725 and Atto740 (all products are manufactured by Atto-TEC GmbH); and VivoTagS680, VivoTag680, and VivoTagS750 (all products are manufactured by VisEn Medical). However, the present invention is not limited only thereto. Ln represents La, Gd, Lu, or Y, Re represents a lanthanide element, M represents an alkali earth metal element, and x represents a number of 0.5 to 1.5. Concerning other examples of the labeling substance, refer to, for example, Japanese Patent No. 4086090 and Japanese Patent Application Laid-Open (JP-A) No.

Subsequently, the detection process is performed [see the detection process in FIG. 6 (D)].

In the detection process, the user first injects an electrolytic solution through the sample inlet 30b of the detection chip 20. Thereafter, the user inserts the detection chip 20 into the chip insertion unit 11 of the detector 1 shown in FIG. 1. Then, the user gives an instruction to start measuring to the detector 1. Here, the electrode leads 71, 72, and 73 of the detection chip 20 inserted into the detector 1 are connected to the ammeter 14 and the power source 15. Then, an arbitrary potential based on the reference electrode 69 is applied to the working electrode 61 by the power source 15 of the detector 1. As the potential to be applied to the electrode, a potential in which the current value (stationary current, dark current) is low when the analyte is not irradiated with excitation light and the photocurrent generated from the analyte becomes a maximum photocurrent is preferred. The potential may be applied to the counter electrode 66 or the working electrode 61.

Thereafter, the light source 13 of the detector 1 emits excitation light to the labeling substance 92 on the working electrode 60. Thus, the labeling substance 92 is excited to generate electrons. The generated electrons move to the working electrode 60. As a result, current flows between the working electrode 60 and the counter electrode 66. Then, the current flowing between the working electrode 60 and the counter electrode 66 is measured by the ammeter 14 of the detector 1. The current value measured by the ammeter 14 correlates with the number of the labeling substance 92. Therefore, the analyte S can be quantified based on the measured current value. The excitation light may be only light in a specified wavelength region, which is obtained using a spectrometer or a bandpass filter, if necessary.

Thereafter, a current value digitally converted by the A/D converting unit 16 is input into the control unit 17. Then, the control unit 17 estimates the amount of the analyte in the sample from the digitally converted current value based on a calibration curve indicating a relationship between a current value created in advance and the amount of the analyte. The control unit 17 creates a detection result screen for displaying the information on the estimated amount of the analyte on the display 12. Thereafter, the detection result screen created by the control unit 17 is sent to the display 12 so as to be displayed on the display 12.

When the labeling substance 92 is irradiated with light, a light source which can emit light in a wavelength capable of photoexciting the labeling substance 92 can be used. The light source can be suitably selected depending on the type of the labeling substance 92. Examples of the light source include fluorescent lamps, black light, bactericidal lamps, incandescent lamps, low-pressure mercury lamps, high-pressure mercury lamps, xenon lamps, mercury-xenon lamps, halogen lamps, metal halide lamps, light emitting diodes (white LED, blue LED, green LED, and red LED), lasers (carbon dioxide lasers, dye lasers, semiconductor lasers), and sunlight. However, the present invention is not limited only thereto. Among the light sources, fluorescent lamps, incandescent lamps, xenon lamps, halogen lamps, metal halide lamps, light emitting diodes, and sunlight are preferred. In the detection process, the labeling substance 92 may be irradiated with only light in a specified wavelength region, which is obtained using a spectrometer or a bandpass filter, if necessary.

In the measurement of a photocurrent derived from the labeling substance 92, for example, a measurement device which includes an ammeter, a potentiostat, a recorder, and a computer can be used.

In the detection process, the amount of the analyte can be examined by quantifying the photocurrent.

In the method for electrochemically detecting an analyte according to the present embodiment, from the viewpoint of suppressing the generation of noises due to contaminants, the user may discharge a remaining liquid containing contaminants from the sample inlet 30b of the detection chip 20 after the process of trapping an analyte and wash the detection chip 20. In the washing of the detection chip 20, organic solvents such as a buffer (particularly a buffer containing a surfactant); purified water (particularly purified water containing a surfactant); and ethanol can be used.

In the method for electrochemically detecting an analyte according to the present embodiment, from the viewpoint of removing the label binding substance 90 which is not bound to the analyte S and improving the detection accuracy, the process of washing the inside of the detection chip 20 to remove the label binding substance 90 may be further performed after the labeling process. For example, ethanol and purified water can be used for the washing.

Further, in the present invention, the operation may be performed so as to form a label binding substance in the labeling process in place of labeling the analyte S using the label binding substance to which the labeling substance is bound in advance in the labeling process.

In the method for electrochemically detecting an analyte according to the present embodiment, the kit may be configured such that the labeling substance 92 and the electrolyte solution are separately stored in different containers.

### EXAMPLES

Hereinafter, the present invention will be described in detail with reference to examples, however, the present invention is not limited thereto.

### Preparation Example 1

1% by volume of 3-mercaptopropyltriethoxysilane (MPTES), i.e., a silane coupling agent, was added to toluene to prepare a solution A.

### Preparation example 2

AlexaFluor750-labeled thiolated DNA [manufactured by Life Technologies, Alexa Fluor 750-5′-GCTTTCTGCGTGAAGACAGTAGTT-SH-3′ (SEQ ID NO: 1), hereinafter referred to as “thiolated DNA”) was added to and dissolved in DNase-free purified water to give a concentration of 100 μM. The resulting thiol group-containing DNA solution was added to Tris-buffered saline [composition: 25 mM tris-HCl (pH 7.4), 0.15 M sodium chloride, hereinafter referred to as “TBS”] so that the concentration of the thiol group containing DNA was 10 nM, and TBS containing the thiol group-containing DNA was obtained.

### Preparation Example 3

An ITO thin film (200 nm in thickness) and an indium oxide thin film (200 nm in thickness) were formed on a substrate body of a glass substrate, in this order, by the spattering method, to produce a working electrode body. Subsequently, a working electrode lead for connecting to the ammeter was connected to the working electrode body to obtain a working electrode substrate. The resulting working electrode substrate was subjected to an UV ozone treatment for 10 minutes and washed, followed by immersing in the resulting solution obtained in Preparation example 1 for 1 hour. Subsequently, the working electrode substrate was washed with toluene and dried at 110° C. for 10 minutes. The working electrode substrate was immersed in toluene, followed by ultrasonic cleaning for 5 minutes to remove MPTES remained on the working electrode substrate.

Silicone rubber formed into a shape of the frame of the working electrode was attached to the working electrode. 10 μL of the TBS containing the thiol group-containing DNA obtained in Preparation example 2 was dropped onto the portion surrounded by the silicone rubber, and allowed to stand at 4° C. overnight to immobilize the thiol group-containing DNA onto the working electrode. The working electrode having the thiol group-containing DNA immobilized onto the working electrode was three times washed with 500 μL of TBS containing Tween-20 (hereinafter, referred to as “TBS-T”) [composition: 25 mM tris-HCl (pH 7.4), 0.15 M sodium chloride, 0.1% by volume of Tween-20], rinsed with ultrapure water, and dried. Then, a working electrode substrate for detecting photocurrent signals derived from the thiol group-containing DNA (hereinafter, also referred to as “signals from the thiol group-containing DNA”) (an electrode substrate 1 for detecting signals) was obtained.

### Preparation Example 4

An ITO thin film (200 nm in thickness) and an indium oxide thin film (200 nm in thickness) were formed on a substrate body of a glass substrate, in this order, by the spattering method, to produce a working electrode body. Subsequently, a working electrode lead for connecting to the ammeter was connected to the working electrode body to obtain a working electrode substrate. The resulting working electrode substrate was subjected to an LTV ozone treatment for 10 minutes and washed, followed by immersing in the resulting solution obtained in Preparation example 1 for 1 hour. Subsequently, the working electrode substrate was washed with toluene and dried at 110° C. for 10 minutes. The working electrode substrate was immersed in toluene, followed by ultrasonic cleaning for 5 minutes to remove MPTES remained on the working electrode substrate. Then, a working electrode substrate for detecting noise from non-specific adsorption (an electrode substrate 1 for detecting noise from non-specific adsorption) was obtained.

### Preparation Example 5

A counter electrode of a 200-nm-thick platinum thin film (conductive layer) was formed on a substrate body of a glass substrate by the spattering method. A counter electrode lead for connecting to the ammeter is connected to the counter electrode to obtain a counter electrode substrate.

### Preparation Example 6

Biotinylated-DNA [5′-TTTCGTTGTCGTGCTTACGATTGCGAGACGTTGTCGTGCTTACGATT GCGAGACGTTGTCGTGCTTACGATTGCGAGTCGTTGTCGTGCTTACGAT TGCGAGT-3′-Biotin (SEQ ID NO: 2] was added to and dissolved in DNase-free purified water to give a concentration of 100 μM. Thus, a biotinylated-DNA solution was obtained.

### Preparation Example 7

AlexaFluor750-labeled DNA [Alexa Fluor 750-5′-CTCGCAATCGTAAGCACGACAACG-Alexa Fluor. 750-3′ (SEQ ID NO: 3)] was added to and dissolved in DNase-free purified water to give a concentration of 100 μM. Thus, an AlexaFluor750-labeled DNA solution was obtained.

### Preparation Example 8

An anti-human IL-6 antibody solution [40 μg/mL, manufactured by BioLegend] was added to 50 μL of a gel for disulfide reduction [manufactured by Thermo Scientific, trade name: Immobilized TCEP GEL]. The mixture was shaken and stirred for 20 minutes to cause a reduction of the heavy chains of the anti-human IL-6 antibody. The resulting mixture was subjected to centrifugation at 4500×g (3000 rpm) for 2 minutes using a micro high-speed centrifuge to recover the supernatant. The resulting supernatant was subjected to gel filtration column chromatography (manufactured by Pharmacia, trade name: Sephadex G25, column size: 0.74 cm²×11 cm, volume: 20 mL) to remove an excessive amount of TCEP. Thus, an antibody solution was obtained. Thereafter, in order to maintain the reducing condition of anti-human IL-6 antibody, TCEP was added to the antibody solution to give a concentration of 20 nM. Thus, a solution containing the antibody with reduced heavy chains was obtained. The solution containing the antibody with reduced heavy chains was diluted with TBS so that the concentration of the reduced heavy chain of anti-human IL-6 antibody was 20 μg/mL to obtain a diluted solution of the antibody.

### Preparation Example 9

A reagent for blocking treatment (manufactured by DS Pharma Biomedical Co., Ltd., trade name: BlockAce) was diluted with a TBS-T solution containing 1% by volume of bovine serum albumin (BSA) (hereinafter referred to as “BSA/TBS-T solution”) to give a concentration of 0.4% by volume. Thus, a diluted solution of the reagent for blocking treatment was obtained.

### Preparation Example 10

A human IL-6 protein solution (manufactured by BioLegend) was diluted with a BSA/TBS-T solution so that the concentration of the human IL-6 protein was 500 pg/mL. Thus, a diluted solution of the human IL-6 protein was obtained.

### Preparation Example 11

A biotin-labeled anti-human IL-6 antibody solution (manufactured by BioLegend) was diluted with a BSA/TBS-T solution so that the concentration of the biotin-labeled anti-human IL-6 antibody was 1 μg/mL. Thus, a diluted solution of the biotin-labeled anti-human IL-6 antibody was obtained.

### Preparation Example 12

The biotinylated-DNA solution obtained in Preparation example 6 was mixed with the AlexaFluor750-labeled DNA solution obtained in Preparation example 7 so that the concentration of the biotinylated-DNA was 10 μM and the concentration of the AlexaFluor750-labeled DNA was 100 μM. Subsequently, the resulting mixture was 10-fold diluted with a 40 mM phosphate buffer (pH 7.4) containing 2 M sodium chloride. The resulting diluted solution was heated at 80° C. for 1 minute. Thereafter, the temperature was decreased to 4° C. over 80 minutes to hybridize the biotinylated-DNA with the AlexaFluor750-labeled DNA. Thus, a polyvalent marker containing solution was obtained. The resulting solution was 10-fold diluted with TBS-T to obtain a diluted solution of the polyvalent marker.

### Preparation Example 13

An ITO thin film (200 nm in thickness) and an indium oxide thin film (200 nm in thickness) were formed on a substrate body of a glass substrate, in this order, by the spattering method, to produce a working electrode body. Subsequently, a working electrode lead for connecting to the ammeter was connected to the working electrode body to obtain a working electrode substrate. The resulting working electrode substrate was subjected to an LTV ozone treatment for 10 minutes and washed, followed by immersing in the resulting solution obtained in Preparation example 1 for 1 hour. Subsequently, the working electrode substrate was washed with toluene and dried at 110° C. for 10 minutes. The working electrode substrate was immersed in toluene, followed by ultrasonic cleaning for 5 minutes to remove MPTES remained on the working electrode substrate.

Silicone rubber formed into a shape of the frame of the working electrode was attached to the working electrode. 15 μL of the antibody diluted solution was dropped onto the portion surrounded by the silicone rubber and allowed to stand at 4° C. overnight to immobilize a reduced heavy chain of anti-human IL-6 antibody onto the working electrode. The working electrode having the antibody immobilized was washed with TBS-T. 40 μL of a TBS solution containing 100 mM triethylene glycol mono-11-mercaptoundecyl ether (hereinafter, referred to as “SH-TEG”) was dropped onto the working electrode and allowed to stand at 4° C. overnight to perform a blocking treatment. Thereafter, an excessive amount of the SH-TEG remained on the working electrode was washed with TBS-T. Subsequently, 50 μL of the diluted solution of the reagent for blocking treatment obtained in Preparation example 9 was dropped onto the working electrode and allowed to stand for 1 hour to perform a blocking treatment. An excessive amount of the reagent for blocking treatment remained on the working electrode was washed with TBS-T. Thereafter, 30 μL of the diluted solution of human IL-6 protein obtained in Preparation example 10 was dropped onto the working electrode and allowed to stand for 1 hour to form an immune complex. Then, an excessive amount of the human IL-6 protein remained on the working electrode was washed with TBS-T. Thereafter, 40 uL of the diluted solution of the labeled anti-human IL-6 antibody obtained in Preparation example 11 was dropped onto the working electrode and allowed to stand for 30 minutes to form an immune complex on the working electrode. An excessive amount of the labeled anti-human IL-6 antibody on the working electrode was washed with TBS-T.

30 μL of the diluted solution of the polyvalent marker obtained in Preparation example 12 was dropped onto the working electrode and allowed to stand for 1 hour to cause a biotin-avidin reaction. Thus, a complex was formed on the working electrode.

The resulting complex on the working electrode was washed twice with TBS-T, rinsed with ultrapure water, and dried. Thus, a working electrode substrate for detecting photocurrent signals derived from the IL-6 antigen (hereinafter, also referred to as “IL-6-derived signals”) (an electrode substrate 2 for detecting signals) was obtained.

### Preparation Example 14

An ITO thin film (200 nm in thickness) and an indium oxide thin film (200 nm in thickness) were formed on a substrate body of a glass substrate, in this order, by the spattering method, to produce a working electrode body. Subsequently, a working electrode lead for connecting to the ammeter was connected to the working electrode body to obtain a working electrode substrate. The resulting working electrode substrate was subjected to an UV ozone treatment for 10 minutes and washed, followed by immersing in the resulting solution obtained in Preparation example 1 for 1 hour. Subsequently, the working electrode substrate was washed with toluene and dried at 110° C. for 10 minutes. The working electrode substrate was immersed in toluene, followed by ultrasonic cleaning for 5 minutes to remove MPTES remained on the working electrode substrate.

Silicone rubber formed into a shape of the frame of the working electrode was attached to the working electrode. 15 μL of the antibody diluted solution was dropped onto the portion surrounded by the silicone rubber and allowed to stand at 4° C. overnight to immobilize a reduced heavy chain of anti-human IL-6 antibody onto the working electrode. The working electrode having the antibody immobilized was washed with TBS-T. 40 μL of a TBS solution containing 100 mM triethylene glycol mono-11-mercaptoundecyl ether (hereinafter, referred to as “SH-TEG”) was dropped onto the working electrode and allowed to stand at 4° C. overnight to perform a blocking treatment. Thereafter, an excessive amount of the SH-TEG remained on the working electrode was washed with TBS-T. Subsequently, 50 μL of the diluted solution of the reagent for blocking treatment obtained in Preparation example 9 was dropped onto the working electrode and allowed to stand for 1 hour to perform a blocking treatment. Thus, a working electrode substrate for detecting the photocurrent noise from the substance non-specifically absorbed to the working electrode (hereinafter referred to as “noise from non-specific adsorption”) (an electrode substrate 2 for detecting noise) was obtained.

### Example 1

1-ethyl-3-methylimidazolium iodide as the imidazolium iodide compound was dissolved in purified water as the protic solvent at room temperature (25° C.) to give a concentration of 5 M. Thus, an electrolyte solution was obtained.

### Comparative Example 1

Tetrapropylammonium iodide and iodine were dissolved in a mixed organic solvent as the aprotic solvent [acetonitrile/ethylene carbonate (volume ratio)=2/3] at room temperature (25° C.) to give concentrations 0.6 M and 0.06 M, respectively. Thus, an electrolyte solution was obtained. The electrolyte solution of Comparative Example 1 is a conventional aprotic solvent system electrolyte solution.

### Test Example 1

12.5 μL of the electrolyte solution obtained in Example 1 or the electrolyte solution obtained in Comparative Example 1 was dropped onto the working electrode of the electrode substrate 1 for detecting signals obtained in Preparation example 3. The working electrode was covered with the counter electrode substrate obtained in Preparation example 5 to fabricate an electrode cell for measuring photocurrents. The labeling substance (Alexa Fluor 750) on the working electrode of the resulting electrode cell was irradiated with laser light (wavelength: 781 nm, strength: 13 mW). Then, the photocurrents of the signals from the thiol group-containing DNA were measured. Further, the photocurrent of noise from non-specific adsorption was measured by performing the same operation except that the electrode substrate 1 for detecting noise obtained in Preparation example 4 was used in place of the probe-immobilized electrode substrate 1 obtained in Preparation example 3.

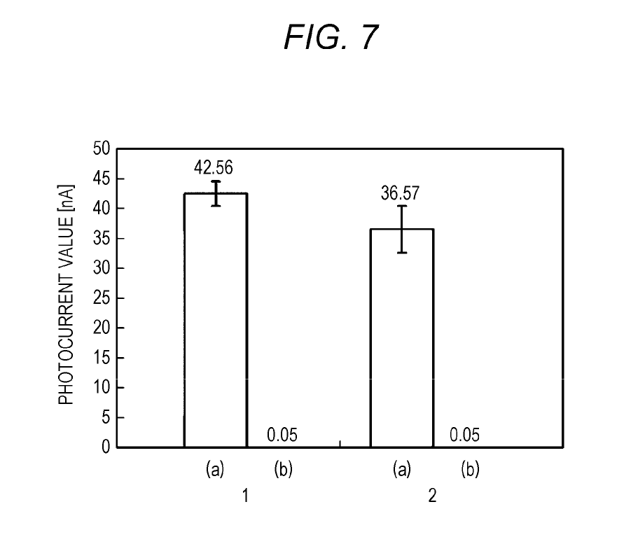

FIG. 7 shows the examined results of the photocurrent values of the signals derived from the thiol group-containing DNA and the photocurrent values of noise from non-specific adsorption when the electrolyte solution obtained in Example 1 and the electrolyte solution obtained in Comparative Example 1 were used in Test example 1. In the drawing, the reference numeral 1 represents a photocurrent value when the electrolyte solution obtained in Example 1 was used and the reference numeral 2 represents a photocurrent value when the electrolyte solution obtained in Comparative Example 1 was used. Further, in the drawing, the symbol (a) represents a photocurrent value of the signal derived from the thiol group-containing DNA, and the symbol (b) represents a photocurrent value of noise from non-specific adsorption.

From the results shown in FIG. 7, it is found that the photocurrent value of the signal derived from the thiol group-containing DNA when the electrolyte solution obtained in Example 1 was used is larger than the photocurrent value of the signal derived from the thiol group-containing DNA when the electrolyte solution obtained in Comparative Example 1 was used. Further, it is found that the photocurrent value of noise from non-specific adsorption when the electrolyte solution obtained in Example 1 was used is equal to the photocurrent value of noise from non-specific adsorption when the electrolyte solution obtained in Comparative Example 1 was used. These results show that, according to the electrolyte solution of the present invention prepared by dissolving an imidazolium iodide compound in a protic solvent, the photocurrent can be detected by the S/N ratio equal to or more than that in the case of using the electrolyte solution prepared by using an aprotic solvent. Therefore, these results suggest that, according to the electrolyte solution of the present invention prepared by dissolving an imidazolium iodide compound in a protic solvent, a nucleic acid (DNA) as an analyte can be detected with high sensitivity.

### Test Example 2

12.5 μL of the electrolyte solution obtained in Example 1 or the electrolyte solution obtained in Comparative Example 1 was dropped onto the working electrode of the electrode substrate 2 for detecting signals obtained in Preparation example 13. The working electrode was covered with the counter electrode substrate obtained in Preparation example 5 to fabricate an electrode cell for measuring photocurrents. The labeling substance (Alexa Fluor 750) on the working electrode of the resulting electrode cell was irradiated with laser light (wavelength: 781 nm, strength: 13 mW). Then, the photocurrents of the IL-6-derived signals were measured. Further, the photocurrent of noise from non-specific adsorption was measured by performing the same operation except that the electrode substrate 2 for detecting noise obtained in Preparation example 14 was used in place of the probe-immobilized electrode substrate 1 obtained in Preparation example 3.

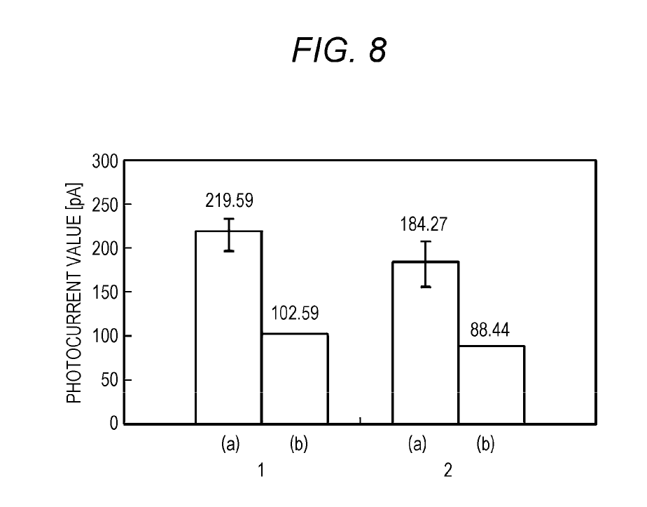

FIG. 8 shows the examined results of the photocurrent values of the IL-6-derived signals and the photocurrent values of noise from non-specific adsorption when the electrolyte solution obtained in Example 1 and the electrolyte solution obtained in Comparative Example 1 were used in Test example 2. In the drawing, the reference numeral 1 represents a photocurrent value when the electrolyte solution obtained in Example 1 was used and the reference numeral 2 represents a photocurrent value when the electrolyte solution obtained in Comparative Example 1 was used. Further, in the drawing, the symbol (a) represents a photocurrent value of the IL-6-derived signal, and the symbol (b) represents a photocurrent value of noise from non-specific adsorption.

From the results shown in FIG. 8, it is found that the photocurrent value of the IL-6-derived signal when the electrolyte solution obtained in Example 1 was used is larger than the photocurrent value of the IL-6-derived signal when the electrolyte solution obtained in Comparative Example 1 was used. Further, it is found that the photocurrent value of noise from non-specific adsorption when the electrolyte solution obtained in Example 1 was used is equal to the photocurrent value of noise from non-specific adsorption when the electrolyte solution obtained in Comparative Example 1 was used. These results show that, according to the electrolyte solution of the present invention prepared by dissolving an imidazolium iodide compound in a protic solvent, the photocurrent can be detected by the S/N ratio equal to or more than that in the case of using the electrolyte solution prepared by using an aprotic solvent. Therefore, these results suggest that, according to the electrolyte solution of the present invention prepared by dissolving an imidazolium iodide compound in a protic solvent, proteins and peptides as the analytes can be detected with high sensitivity.

### Example 2

1-ethyl-3-methylimidazolium iodide as the imidazolium iodide compound was dissolved in purified water as the protic solvent at room temperature (25° C.) to give a concentration of 3 M. Thus, an electrolyte solution was obtained.

### Examples 3 and 4

1-methyl-3-propylimidazolium iodide as the imidazolium iodide compound was dissolved in purified water as the protic solvent at room temperature (25° C.) to give a concentration of 3 M (Example 3) or 5 M (Example 4). Thus, an electrolyte solution was obtained.

### Examples 5 and 6

1-propyl-2,3-dimethylimidazolium iodide as the imidazolium iodide compound was dissolved in purified water as the protic solvent at room temperature (25° C.) to give a concentration of 3 M (Example 5) or 5 M (Example 6). Thus, an electrolyte solution was obtained.

### Test Example 3

12.5 μL of the electrolyte solutions obtained in Examples 1 to 6 was dropped onto the working electrode of the electrode substrate 1 for detecting signals obtained in Preparation example 3. The working electrode was covered with the counter electrode substrate obtained in Preparation example 5 to fabricate an electrode cell for measuring photocurrents. The labeling substance (Alexa Fluor 750) on the working electrode of the resulting electrode cell was irradiated with laser light (wavelength: 781 nm, strength: 5 mW). Then, the photocurrents of the signals from the thiol group-containing DNA were measured.

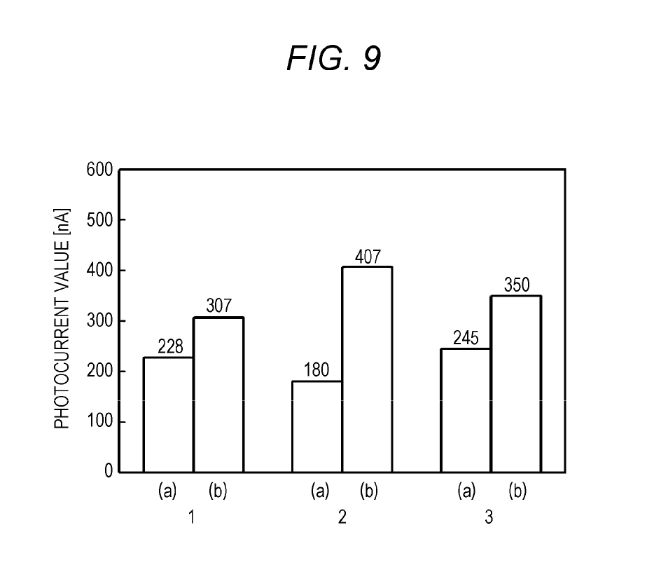

FIG. 9 shows the examined results of the photocurrent values of the signals derived from the thiol group-containing DNA when the resulting electrolyte solutions obtained in Examples 1 to 6 were used in Test example 3. In the drawing, the reference numeral 1 represents an electrolyte solution prepared by using 1-ethyl-3-methylimidazolium iodide, the reference numeral 2 represents an electrolyte solution prepared by using 1-methyl-3-propylimidazolium iodide, and the reference numeral 3 represents an electrolyte solution prepared by using 1-propyl-2,3-dimethylimidazolium iodide. In the drawing, the reference numeral 1(a) represents a photocurrent value of the signal derived from the thiol group-containing DNA when the electrolyte solution obtained in Example 2 was used, the reference numeral 1(b) represents a photocurrent value of the signal derived from the thiol group-containing DNA when the electrolyte solution obtained in Example 1 was used, the reference numeral 2(a) represents a photocurrent value of the signal derived from the thiol group-containing DNA when the electrolyte solution obtained in Example 3 was used, the reference numeral 2(b) represents a photocurrent value of the signal derived from the thiol group-containing DNA when the electrolyte solution obtained in Example 4 was used, the reference numeral 3(a) represents a photocurrent value of the signal derived from the thiol group-containing DNA when the electrolyte solution obtained in Example 5 was used, and the reference numeral 3(b) represents a photocurrent value of the signal derived from the thiol group-containing DNA when the electrolyte solution obtained in Example 6 was used.

From the results shown in FIG. 9, it is found that the photocurrent value becomes higher depending on the amount of the imidazolium iodide compound contained in the electrolyte solution.

### Examples 7 to 14 and Comparative Examples 2 to 6

12.5 μL of the electrolyte solution was dropped onto the working electrode of the electrode substrate 1 for detecting signals obtained in Preparation example 3. The working electrode was covered with the counter electrode substrate obtained in Preparation example 5 to fabricate an electrode cell for measuring photocurrents. The labeling substance (Alexa Fluor 750) on the working electrode of the resulting electrode cell was irradiated with laser light (wavelength: 781 nm, strength: 5.5 mW). Then, the photocurrents of the signals from the thiol group-containing DNA were measured. Further, the photocurrent of noise from non-specific adsorption was measured by performing the same operation except that the electrode substrate 1 for detecting noise obtained in Preparation example 4 was used in place of the probe-immobilized electrode substrate 1 obtained in Preparation example 3. The photocurrent S/N ratio was calculated from the resulting photocurrent value of the signal derived from the thiol group-containing DNA and the photocurrent value of noise from non-specific adsorption.

As the electrolyte solution, a saturated electrolyte solution under the condition where the photocurrent value became the highest was used. As the electrolyte solution, the following solutions were used: a saturated 1-ethyl-3-methylimidazolium iodide (EMImI) solution (concentration of EMImI: 5.92 M, the value of Formula (II): 2, Example 7); a saturated 1-propyl-3-methylimidazolium iodide (PMImI) solution (concentration of PMImI: 6.86 M, the value of Formula (II):3, Example 8); a saturated 1-allyl-3-methylimidazolium iodide (AMImI) solution (concentration of AMImI: 3.42 M, the value of Formula (II): 3, Example 9); a saturated 1-butyl-3-methylimidazolium iodide (BMImI) solution (concentration of BMImI: 5.68 M, the value of Formula (II): 4, Example 10); a saturated 1-hexyl-3-methylimidazolium iodide (HMImI) solution (concentration of HMImI: 5.35 M, the value of Formula (II): 6, Example 11); a saturated 1-propyl-2,3-dimethylimidazolium iodide (PMMImI) solution (concentration of PMMImI: 5.40 M, the value of Formula (II): 1.5, Example 12); a saturated 1-butyl-2,3-dimethylimidazolium iodide (BMMImI) solution (concentration of BMMImI: 4.12 M, the value of Formula (II): 2, Example 13); a saturated 1-hexyl-2,3-dimethylimidazolium iodide (HMMImI) solution (concentration of HMMImI: 3.31 M, the value of Formula (II): 3, Example 14); a saturated tetrapropylammonium iodide (NPr4I) solution (concentration of NPr4I: 0.50 M, Comparative Example 2); a saturated tetramethylammonium iodide (NMe4I) solution (concentration of NMe4I: 0.24 M, Comparative Example 3); a saturated 2-chloro-1 methylpyridinium iodide (CMPyI) solution (concentration of CMPyI: 3.39, Comparative Example 4); a saturated lithium iodide (LiI) solution (concentration of LiI: 6.98, Comparative Example 5) or a mixed organic solvent solution of tetrapropylammonium iodide (NPr4I) and iodine [acetonitrile/ethylene carbonate (volume ratio)=2/3] (concentration of NPr4I: 0.6 M, concentration of I2: 0.06 M, Comparative Example 6). The electrolyte solution of Comparative Example 6 is the same as that of Comparative Example 1.

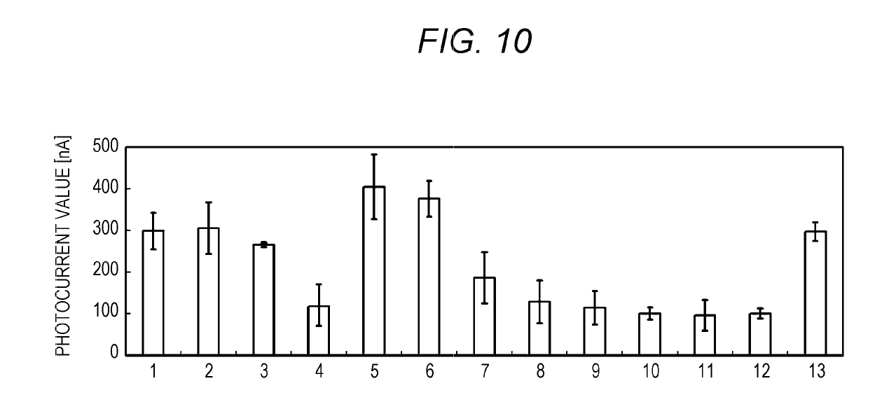

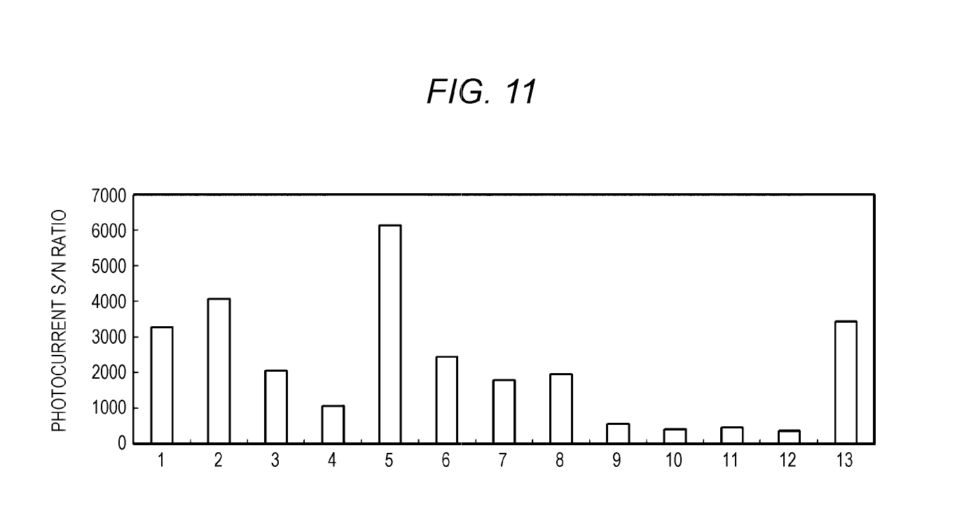

FIG. 10 shows the examined results of the photocurrent values of the signals derived from the thiol group-containing DNA when the electrolyte solutions of Examples 7 to 14 and Comparative Examples 2 to 6 were used. FIG. 11 shows the examined results of the photocurrent S/N values when the electrolyte solutions of Examples 7 to 14 and Comparative Examples 2 to 6 were used. In the drawing, the reference numeral 1 represents a saturated EMImI solution (Example 7), the reference numeral 2 represents a saturated PMImI solution (Example 8), the reference numeral 3 represents a saturated AMImI solution (Example 9), the reference numeral 4 represents a saturated BMImI solution (Example 10), the reference numeral 5 represents a saturated HMImI solution (Example 11), the reference numeral 6 represents a saturated PMMImI solution (Example 12), the reference numeral 7 represents a saturated BMMImI solution (Example 13), the reference numeral 8 represents a saturated HMMImI solution (Example 14), the reference numeral 9 represents a saturated NPr4I solution (Comparative Example 2), the reference numeral 10 represents a saturated NMe4I solution (Comparative Example 3), the reference numeral 11 represents a saturated CMPyI solution (Comparative Example 4), the reference numeral 12 represents a saturated LiI solution (Comparative Example 5), and the reference numeral 13 represents a mixed organic solvent solution of NPr4I (Comparative Example 6).

From the results shown in FIG. 10, it is found that the photocurrent values (Lanes 1 to 8) when the electrolyte solutions of Examples 7 to 14 prepared by using the imidazolium iodide compound and water (as the protic solvent) was used are higher than the photocurrent values (Lanes 9 to 12) when the electrolyte solutions of Comparative Examples 2 to 6 prepared by using other iodide compounds and the protic solvent were used. From the results shown in FIG. 11, it is found that the photocurrent S/N ratios (Lanes 1 to 8) when the electrolyte solutions of Examples 7 to 14 prepared by using the imidazolium iodide compound and water (as the protic solvent) were used are significantly higher than the photocurrent S/N ratios (Lanes 9 to 12) when the electrolyte solutions of Comparative Examples 2 to 6 prepared by using other iodide compounds and the protic solvent were used. It is found that, particularly, in the case of using EMImI, PMImI, HMImI or PMMImI, a photocurrent value equal to or more than the photocurrent value when the electrolyte solution of Comparative Example 6 (as the conventional aprotic solvent system electrolyte solution) was used is obtained, in the case of using EMImI, PMImI or HMImI, a photocurrent S/N ratio equal to or more than the photocurrent S/N ratio when the electrolyte solution of Comparative Example 6 (as the conventional aprotic solvent system electrolyte solution) was used is obtained. Therefore, these results suggest that, according to the electrolyte solution of the present invention prepared by dissolving an imidazolium iodide compound in a protic solvent, the solvent does not have to be replaced during the processes of capturing the analyte on the working electrode and measuring the photocurrents, like the case of using an aprotic solvent-based electrolyte solution, and proteins and peptides as the analytes can be detected with the same high detection sensitivity as that of the case of using an aprotic solvent-based electrolyte solution.

What is claimed is:

1. A method for electrochemically detecting an analyte contained in a sample using a working electrode and a counter electrode, comprising:
allowing an electrolyte solution which contains a solution prepared by dissolving an imidazolium iodide compound in a protic solvent to be into contact with the working electrode and the counter electrode; and
electrochemically detecting the analyte contained in the sample in the presence of the electrolyte solution.

2. The method according to claim 1, wherein the imidazolium iodide compound is an imidazolium iodide compound represented by Formula (I) 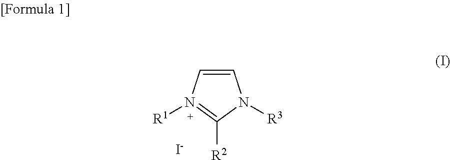
(wherein R¹, R², and R³ each independently represent a hydrogen atom, a monovalent hydrocarbon group having 1 to 8 carbon atoms or an alkoxy group having 1 to 8 carbon atoms, wherein the case where all of R¹, R², and R³ represent a hydrogen atom is excluded).

3. The method according to claim 2, wherein the imidazolium iodide compound is an imidazolium iodide compound, wherein in Formula (I), one of R¹ to R³ or two of R¹ to R³ represent a monovalent hydrocarbon group having 1 to 8 carbon atoms.

4. The method according to claim 2, wherein the imidazolium iodide compound is an imidazolium iodide compound, wherein a value calculated by Formula (II):
[the number of carbon atoms of a hydrocarbon group with the greatest number of carbon atoms/the number of carbon atoms of other hydrocarbon groups]
is 3 or less.

5. The method according to claim 2, wherein the imidazolium iodide compound is an imidazolium iodide compound, wherein in Formula (I), one of R¹ to R³ has a hexyl group.

6. The method according to claim 1, wherein the imidazolium iodide compound is at least one of 1-ethyl-3-methylimidazolium iodide, 1-propyl-3-methylimidazolium iodide, 1-hexyl-3-methylimidazolium iodide, and 1-propyl-2,3-dimethylimidazolium iodide.

7. The method according to claim 6, wherein the imidazolium iodide compound is at least one of 1-ethyl-3-methylimidazolium iodide, 1-propyl-3-methylimidazolium iodide, and 1-hexyl-3-methylimidazolium iodide.

8. The method according to claim 7, wherein the imidazolium iodide compound is at least one of 1-hexyl-3-methylimidazolium iodide.

9. The method according to claim 1, wherein the protic solvent is water.

10. The method according to claim 1, wherein the electrolyte solution contains an imidazolium cation at a concentration of 0.01 mol/L or more.

11. The method according to claim 10, wherein the electrolyte solution contains an imidazolium cation at a concentration of 0.1 mol/L or more.

12. The method according to claim 1, wherein the electrolyte solution contains an imidazolium cation at a concentration of 20 mol/L or less.

13. The method according to claim 12, wherein the electrolyte solution contains an imidazolium cation at a concentration of 10 mol/L or less.

14. The method for electrochemically detecting an analyte according to claim 1, comprising:
(1) allowing a labeling substance from which electrons originate via photoexcitation to be present on the working electrode in an amount corresponding to the amount of the analyte in the sample;
(2) irradiating the labeling substance with light in a state where the electrolyte solution is in contact with the working electrode and the counter electrode; and
(3) measuring the electric current which flows between the working electrode and the counter electrode due to the movement of electrons from the labeling substance excited by light irradiation to the working electrode.

15. The method according to claim 14, wherein the step (1) comprises the steps of
(A-1) bringing a working electrode having a probe capable of trapping an analyte immobilized thereon into contact with a sample containing the analyte so as to capture the analyte on the working electrode; and
(A-2) introducing a labeling substance into the analyte captured on the working electrode.

16. The method according to claim 14, wherein the working electrode is a working electrode having a probe capable of trapping an analyte immobilized thereon, and
the step (1) comprises the steps of:
(B-1) introducing a labeling substance into an analyte contained in a sample; and
(B-2) bringing the working electrode into contact with the sample so as to capture the analyte on the probe on the working electrode.

17. A kit to be used for the method for electrochemically detecting an analyte, comprising:
an electrolyte solution which is used for the method for electrochemically detecting an analyte contained in a sample in the presence of an electrolyte solution using a working electrode and a counter electrode; and
a labeling substance from which electrons originate via photoexcitation;
wherein the electrolyte solution is a solution prepared by dissolving an imidazolium iodide compound in a protic solvent.

18. The kit according to claim 17, wherein the imidazolium iodide compound is an imidazolium iodide compound represented by Formula (I): 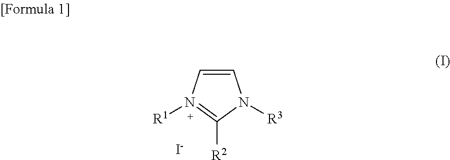
(wherein R¹, R², and R³ each independently represent a hydrogen atom, a monovalent hydrocarbon group having 1 to 8 carbon atoms or an alkoxy group having 1 to 8 carbon atoms, wherein the case where all of R¹, R², and R³ represent a hydrogen atom is excluded).

19. The kit according to claim 18, wherein the imidazolium iodide compound is an imidazolium iodide compound, wherein in Formula (I), one of R¹ to R³ or two of R¹ to R³ represent a monovalent hydrocarbon group having 1 to 8 carbon atoms.

20. The kit according to claim 18, wherein the imidazolium iodide compound is an imidazolium iodide compound, wherein a value calculated by Formula (II):
[the number of carbon atoms of a hydrocarbon group with the greatest number of carbon atoms/the number of carbon atoms of other hydrocarbon groups]
is 3 or less.


SEQUENCE LISTING (3 sequences)

SEQ ID NO: 1 - DNA, 24 bp, Artificial
  A sequence of DNA having thiol group
gctttctgcgtgaagacagtagtt

SEQ ID NO: 2 - DNA, 103 bp, Artificial
  A sequence of biotinylated DNA
tttcgttgtcgtgcttacgattgcgagacgttgtcgtgcttacgattgcgagacgttgtcgtgcttacgattgcgagtcgttgtcgtgcttacgattgcgagt

SEQ ID NO: 3 - DNA, 24 bp, Artificial
  A sequence of AlexaFluor750 labeled DNA
ctcgcaatcgtaagcacgacaacg